(19) United States
(12) Patent Application Publication
(10) Pub. No.: US 2025/0178020 A1
(43) Pub. Date: Jun. 5, 2025

(54) POWDER AMOUNT ADJUSTMENT UNIT AND POWDER COATING DEVICE

(71) Applicant: Panasonic Intellectual Property Management Co., Ltd., Osaka (JP)

(72) Inventors: TOSHIYUKI KOJIMA, Kyoto (JP); SHUZO TSUCHIDA, Nara (JP)

(21) Appl. No.: 19/051,293

(22) Filed: Feb. 12, 2025

Related U.S. Application Data
(63) Continuation of application No. PCT/JP2023/022810, filed on Jun. 20, 2023.

(30) Foreign Application Priority Data
Aug. 30, 2022 (JP) 2022-137223

(51) Int. Cl. B05C 11/02; B05B 7/14

(52) U.S. Cl. CPC B05C 11/025; B05B 7/14

(57) ABSTRACT

Powder amount adjustment unit (11) adjusts the amount of powder (4) by leveling powder (4) supplied onto sheet (5). Powder amount adjustment unit (11) includes squeegee (1) having a first end and a second end, first vibrator (2) that is disposed at the first end of squeegee (1) and excites a wave at the first end of squeegee (1), and second vibrator (3) that is disposed at the second end of squeegee (1) and absorbs the wave at the second end of squeegee (1). Squeegee (1) vibrates with a traveling wave from the first end toward the second end of squeegee (1).

### TECHNICAL FIELD

The present disclosure relates to a powder amount adjustment unit and a powder coating device.

### BACKGROUND ART

In recent years, a dry coating method of directly coating powder has attracted attention as a method that enables a powder layer having high performance and a small environmental load to be formed as compared with a wet coating method of dispersing powder in a solvent before coating. According to the dry coating method, a powder layer (i) that is less damaged by the solvent, can maintain high performance, (ii) not requiring drying of the solvent, and greatly reducing the amount of consumption energy.

As a method for performing dry coating on powder, conventionally, a technique is widely known in which a surface of a base material such as a metal foil is coated with powder while conveying the base material.

For example, PTL 1 discloses a technique of coating powder onto a surface of a long metal foil. PTL 1 describes that the powder is applied onto a surface of the metal foil, and thereafter, the powder is leveled by a squeegee that vibrates the powder to uniformly adjust a thickness of a powder layer. In the present specification, a mechanism that includes a squeegee and adjusts the powder amount by leveling the powder supplied onto a base material such as a metal foil is referred to as a powder amount adjustment unit.

### CITATION LIST

### Patent Literature

PTL 1: Unexamined Japanese Patent Publication No. 2021-178271

### SUMMARY OF THE INVENTION

A powder amount adjustment unit according to one aspect of the present disclosure is a powder amount adjustment unit that adjusts an amount of powder by leveling the powder supplied onto a base material, the powder amount adjustment unit including a squeegee including a first end and a second end, a first vibrator that is disposed at the first end of the squeegee and excites a wave at the first end, and a second vibrator that is disposed at the second end of the squeegee and absorbs the wave at the second end, in which the squeegee vibrates with a traveling wave from the first end toward the second end.

### BRIEF DESCRIPTION OF THE DRAWINGS

FIG. 1 is a diagram illustrating an example of a powder coating device.

FIG. 2A is a diagram illustrating a squeegee included in the powder coating device illustrated in FIG. 1 as viewed from the front.

FIG. 2B is a diagram illustrating a powder layer coated by the powder coating device illustrated in FIG. 1 as viewed from the front.

FIG. 3 is a perspective view illustrating a powder amount adjustment unit according to an exemplary embodiment.

FIG. 4 is a diagram illustrating the powder amount adjustment unit according to the exemplary embodiment as viewed from the front.

FIG. 5 is a diagram illustrating the vicinity of the powder amount adjustment unit of the powder coating device according to the exemplary embodiment.

FIG. 6 is a diagram illustrating the powder coating device according to the exemplary embodiment as viewed from the front.

### DESCRIPTION OF EMBODIMENT

### (Background of One Aspect of the Present Disclosure)

First, how the inventors of the present invention have obtained one aspect of the present disclosure will be described.

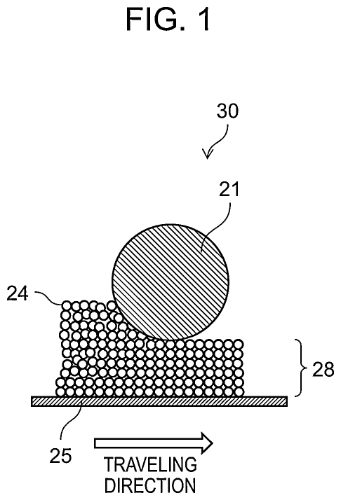

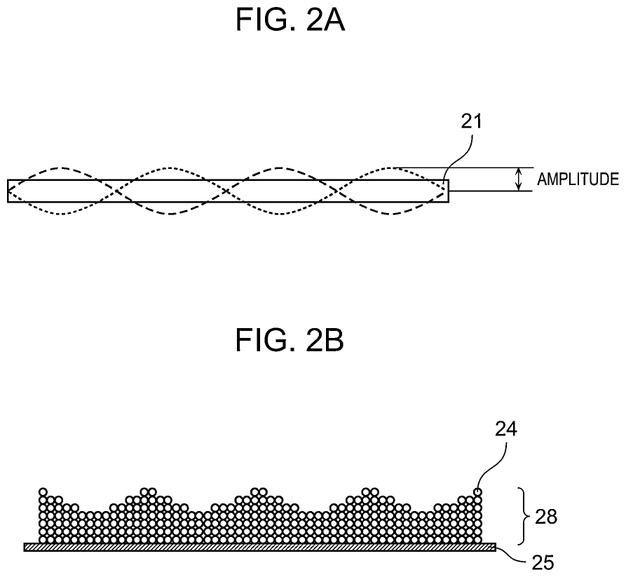

FIG. 1 is a diagram illustrating an example of powder coating device 30. FIG. 2A is a diagram illustrating squeegee 21 included in powder coating device 30 illustrated in FIG. 1 as viewed from the front in a traveling direction of sheet 25. FIG. 2B is a diagram illustrating powder layer 28 coated by powder coating device 30 illustrated in FIG. 1 as viewed from the front. FIG. 2A schematically illustrates a vibration waveform when squeegee 21 resonates (natural vibration) with a sinusoidal stationary wave when squeegee 21 is viewed from the front.

As illustrated in FIG. 1, squeegee 21 levels powder 24 supplied onto sheet 25 while vibrating at a high frequency (for example, frequency of more than or equal to 2 kHz and 300 kHz) in the vicinity of the ultrasonic band with a vibration generator such as a vibrator not illustrated, for example, to form powder layer 28. In powder coating device 30, for example, sheet 25 moves in the direction indicated by the outlined arrow, and thus powder 24 passes through the gap between sheet 25 and squeegee 21 to form powder layer 28. At this time, the vibration is transmitted to powder 24 to improve flowability of powder 24, thereby realizing coating without powder clogging.

As illustrated in FIG. 2A, when squeegee 21 is vibrated at a high frequency, squeegee 21 vibrates with a sinusoidal stationary wave due to resonance (natural vibration). Thus, as illustrated in FIG. 2B, an uneven structure scraped in a sinusoidal stationary wave shape is formed on the surface of powder layer 28 that has passed through the gap between sheet 25 and squeegee 21. As a result, the variation in the basis weight increases in powder layer 28.

In this manner, the inventors of the present invention have paid attention to the fact that, when a squeegee is vibrated to improve the flowability of powder in the formation of a powder layer, variation in the basis weight of the powder layer due to the vibration of the squeegee may occur. In the powder layer formed by the dry coating method, uniformity of the basis weight may be required to improve the quality of the powder layer. The present disclosure provides a powder amount adjustment unit and the like capable of forming a powder layer with reduced variation in basis weight even when a squeegee is vibrated.

### (Outline of Present Disclosure)

Hereinafter, an example of a powder amount adjustment unit and a powder coating device according to the present disclosure will be described.

A powder amount adjustment unit according to a first aspect of the present disclosure is a powder amount adjustment unit that adjusts an amount of powder by leveling the powder supplied onto a base material, the powder amount adjustment unit including a squeegee including a first end and a second end, a first vibrator that is disposed at the first end of the squeegee and excites a wave at the first end, and a second vibrator that is disposed at the second end of the squeegee and absorbs the wave at the second end, in which the squeegee vibrates with a traveling wave from the first end toward the second end.

With this configuration, the first vibrator that excites a wave and the second vibrator that absorbs a wave are disposed at both ends of the squeegee, and thus a traveling wave traveling from the first vibrator to the second vibrator is generated in the squeegee. For this reason, antinodes and nodes of vibration such as a sinusoidal stationary wave are not generated in the squeegee. Thus, unevenness derived from the vibration of the squeegee are less likely to occur in the powder layer formed by leveling the powder, and the powder layer with reduced variation in basis weight can be formed.

For example, a powder amount adjustment unit according to a second aspect of the present disclosure is the powder amount adjustment unit according to the first aspect, in which the squeegee is made of a metal material.

As a result, waves are less likely to be attenuated in the squeegee, and variations in the basis weight of the powder layer to be formed can be further reduced.

For example, a powder amount adjustment unit according to a third aspect of the present disclosure is the powder amount adjustment unit according to the first aspect or the second aspect, in which the squeegee vibrates at a frequency of more than or equal to 2 kHz and less than or equal to 300 kHz.

As a result, the squeegee vibrates at a high frequency, the vibration is transmitted to the powder, the flowability of the powder is improved, and thus the powder is not clogged when the powder is leveled by the squeegee, and stable powder amount adjustment can be realized.

A powder coating device according to a fourth aspect of the present disclosure includes a powder supply unit that supplies powder onto a surface of a base material, the powder amount adjustment unit according to any one of the first aspect to the third aspect that is a powder amount adjustment unit in which the squeegee is disposed with a gap formed between the squeegee and the base material, and a drive unit that moves the base material with respect to the squeegee in a predetermined direction.

As a result, since the powder coating device includes the powder amount adjustment unit, it is possible to form a powder layer with reduced variation in basis weight.

For example, a powder coating device according to a fifth aspect of the present disclosure is the powder coating device according to the fourth aspect, the powder coating device including a pair of support columns supporting the squeegee, in which the pair of support columns is disposed on an outer side with respect to the first vibrator and the second vibrator, and the first vibrator and the second vibrator are sandwiched between the pair of support columns.

As a result, the support column can suppress attenuation of the traveling wave of the squeegee and support the squeegee.

Hereinafter, exemplary embodiments of the present disclosure will be described with reference to the drawings.

The exemplary embodiments described below are intended to provide comprehensive or specific examples. Numerical values, shapes, materials, constituent elements, disposition positions and connection modes of the constituent elements, steps, order of the steps, and the like illustrated in the exemplary embodiments below are merely examples, and are not intended to limit the present disclosure. Among the constituent elements in the following exemplary embodiments, constituent elements not recited in the independent claims are described as optional constituent elements.

In the present specification, a term indicating the relationship between elements such as parallel, a term indicating the shape of an element such as rectangular, and a numerical range not only mean strict meanings but also include substantially equivalent relationship, for example, a relationship with difference by a several percent.

The drawings are schematic views including emphasis, omission, and proportional adjustment as required to illustrate the present disclosure. These drawings are not strictly illustrated but may include shape, positional relationship, and percentage that differ from the actual ones. In the drawings, substantially identical configurations are denoted by the same reference mark, and duplicate description may be omitted or simplified.

### Exemplary Embodiment

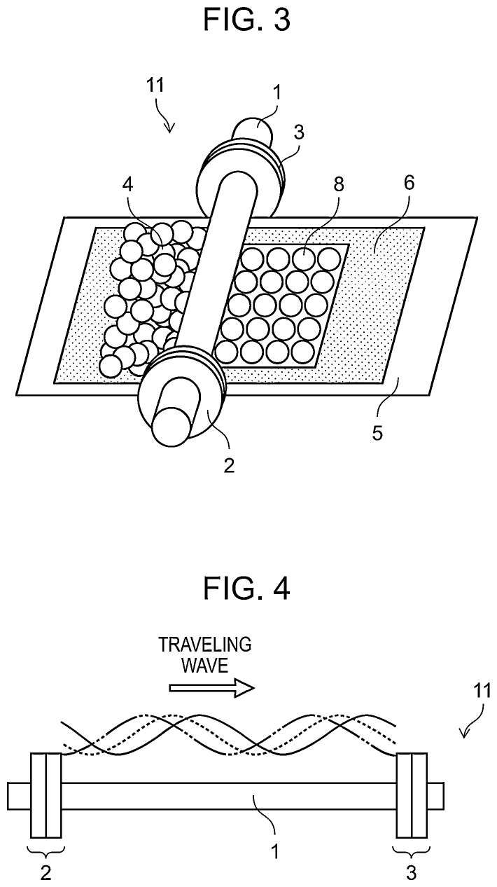

Hereinafter, an exemplary embodiment is described with reference to FIGS. 3 to 6.

### [Powder Amount Adjustment Unit]

First, a powder amount adjustment unit according to the present exemplary embodiment will be described with reference to FIGS. 3 and 4. FIG. 3 is a perspective view illustrating powder amount adjustment unit 11 according to the present exemplary embodiment. FIG. 4 is a diagram illustrating powder amount adjustment unit 11 according to the present exemplary embodiment as viewed from the front. FIG. 4 schematically illustrates a vibration waveform when squeegee 1 vibrates with a traveling wave when squeegee 1 is viewed from the front. In FIG. 4, the time change of the vibration waveform is illustrated by waveforms indicated by different line types. In FIG. 4, “as viewed from the front” is a case of being viewed from the front in a relative movement direction of powder 4 with respect to squeegee 1.

As illustrated in FIGS. 3 and 4, powder amount adjustment unit 11 includes squeegee 1 having a first end and a second end, first vibrator 2 that is disposed at the first end of squeegee 1 and excites a wave at the first end, and second vibrator 3 that is disposed at the second end of squeegee 1 and absorbs a wave at the second end. Powder amount adjustment unit 11 adjusts the amount of powder 4 by leveling powder 4 supplied onto sheet 5 using squeegee 1 to form powder layer 8.

In the present exemplary embodiment, squeegee 1 has an elongated shape, and first vibrator 2 and second vibrator 3 are disposed, for example, at both ends (first end and second end) in a longitudinal direction of squeegee 1. In the present specification, the “end” of squeegee 1 does not mean only an edge of squeegee 1 in a certain direction, but means a region in a predetermined range from an edge of squeegee 1 in a certain direction. Specifically, in the present exemplary embodiment, the “end” is a region outside a region through which powder 4 passes in squeegee 1. The “end” may be a region in a range of less than or equal to 25% of the length of squeegee 1 in a certain direction from an edge of squeegee 1 in the certain direction. Further, in the present specification, “long” means that the length in a certain direction is twice or more the length in any direction orthogonal to the certain direction.

Squeegee 1 vibrates with a traveling wave from the first end toward the second end of squeegee 1 generated by first vibrator 2 and second vibrator 3. Thus, the position where the amplitude is maximized in squeegee 1 moves with time. In the example illustrated in FIGS. 3 and 4, the traveling wave travels in the longitudinal direction of squeegee 1. When powder layer 8 is formed, the longitudinal direction of squeegee 1 is, for example, a direction intersecting (specifically, orthogonal to) the relative traveling direction of squeegee 1 with respect to sheet 5 in a top view of sheet 5. That is, in squeegee 1, the traveling direction of the traveling wave intersects (specifically, is orthogonal to) a relative traveling direction of squeegee 1 with respect to sheet 5.

Mask 6 having an opening is disposed on sheet 5. Powder 4 is deposited on sheet 5 through the opening of mask 6. Powder amount adjustment unit 11 (squeegee 1) moves relative to sheet 5 to adjust the film thickness and the filling rate of powder 4. As a result, powder layer 8 containing a desired amount (hereinafter, the basis weight) of powder 4 and having little variation in the basis weight is formed. In the present exemplary embodiment, sheet 5 is an example of the base material.

Here, the basis weight is a value indicating the amount of powder per unit area by weight, and the unit of the basis weight is indicated by, for example, g/cm².

In the formation of powder layer 8, it is sufficient that squeegee 1 and powder 4 move relative to each other, and sheet 5 and mask 6 may be moved while powder amount adjustment unit 11 is fixed. In the formation of powder layer 8, powder amount adjustment unit 11 and both sheet 5 and mask 6 may be moved. Means for moving them is not particularly limited, and a drive device may be used, or they may be moved manually.

In the formation of powder layer 8, a predetermined gap is formed between squeegee 1 and sheet 5. For example, a gap is formed between squeegee 1 and sheet 5 by bringing squeegee 1 into contact with the upper surface of mask 6. That is, the gap is adjusted by the thickness of mask 6. Powder 4 supplied onto sheet 5 passes through this gap. When powder 4 passes through the gap, squeegee 1 adjusts the film thickness and filling rate of powder 4 supplied to the surface of sheet 5 to reduce variation in the basis weight of powder layer 8.

In the present exemplary embodiment, sheet 5 is, for example, a current collector including a metal foil, but the material and shape of the base material to which powder 4 is supplied are not particularly limited.

Powder 4 is not limited as long as it is a powdery substance. That is, the raw material of powder 4, the composition of powder 4, and the particle shape of powder 4 are not particularly limited. In the present exemplary embodiment, powder 4 is a group of particles containing at least either an active material or a solid electrolyte.

The particle size (D50) of powder 4 is, for example, more than or equal to 0.005 μm and less than or equal to 30 μm. When the particle size of powder 4 is reduced, the flowability of powder 4 tends to decrease, but the flowability of powder 4 is promoted by the vibration of squeegee 1. Thus, the stagnation and aggregation of powder 4 are suppressed, and thus powder layer 8 having little variation in basis weight can be formed. The particle size (D50) may be a volume-based median diameter calculated from a measurement value of particle size distribution by a laser diffraction and scattering method. The particle size (D50) can be measured by using a commercially available laser analysis and scattering type particle size distribution measurement device.

Powder 4 may contain only one type of powder or two or more types of powder.

Hereinafter, details of squeegee 1, first vibrator 2, and second vibrator 3 will be described.

### [Squeegee, First Vibrator, and Second Vibrator]

Since squeegee 1 vibrates with a traveling wave formed by first vibrator 2 and second vibrator 3, nodes and antinodes of the vibration of squeegee 1 do not occur unlike the case of vibrating with a sinusoidal stationary wave. That is, the position where the amplitude is maximized and the position where the amplitude is minimized in squeegee 1 change. Thus, variations in basis weight caused by nodes and antinodes of vibration of squeegee 1 do not occur, and thus powder layer 8 having little variation in basis weight in a coating width direction can be formed. In the present specification, the coating width direction of powder layer 8 may be simply referred to as “width direction”.

Hereinafter, details of generation of the traveling wave in squeegee 1 will be described.

As described above, first vibrator 2 and second vibrator 3 are disposed at the first end and the second end of squeegee 1, respectively, and are connected to the first end and the second end. Specifically, first vibrator 2 is attached to the first end of squeegee 1 in the longitudinal direction of squeegee 1. Second vibrator 3 is attached to the second end of squeegee 1 in the longitudinal direction of squeegee 1. First vibrator 2 is an excitation vibrator that excites a wave. Second vibrator 3 is an absorption vibrator that absorbs a wave. As a result, a wave is oscillated from first vibrator 2 serving as an excitation vibrator, the wave is absorbed by second vibrator 3 serving as an absorption vibrator, and thus a traveling wave is propagated to squeegee 1. That is, first vibrator 2 and second vibrator 3 generate a traveling wave in squeegee 1. Since squeegee 1 levels powder 4 using the vibration of the traveling wave, it is possible to suppress variation in the powder basis weight in the width direction of powder layer 8 caused by the antinode and node portions of the stationary wave. That is, powder amount adjustment unit 11 can form powder layer 8 having little variation in basis weight in the width direction. The width direction of powder layer 8 is a direction orthogonal to a thickness direction of powder layer 8 and a direction in which squeegee 1 moves with respect to powder 4.

Squeegee 1 is made of, for example, a metal material. Using a metal material as the material of squeegee 1 makes it possible to suppress attenuation of high frequency waves propagating through squeegee 1. This is because a high frequency having a short wavelength is easily attenuated, but a metal material easily transmits a wave, and thus attenuation can be suppressed. Thus, an increase in amplitude on the side of first vibrator 2 that excites a wave is suppressed, and the vibration state can be brought close to the same level between the portion close to first vibrator 2 and the portion close to second vibrator 3 in squeegee 1. Thus, the variation in powder basis weight in the width direction of powder layer 8 is further reduced. Squeegee 1 may contain a material other than the metal material. For example, squeegee 1 may be a composite member made of a resin material and a metal material in which a portion where a traveling wave propagates is formed of a metal material. Squeegee 1 may be made of a ceramic material.

As the metal material, for example, stainless steel, titanium, aluminum, copper, iron, nickel, or the like is used. Among these metal materials, stainless steel or titanium may be used from the viewpoint of high corrosion resistance and resistance to rust. When titanium, which is a light material, is used as the metal material, it is easy to vibrate at a high frequency.

Each of first vibrator 2 and second vibrator 3 includes, for example, a plurality of piezoelectric bodies and an electrode provided on an end surface of each of the plurality of piezoelectric bodies. In first vibrator 2 and second vibrator 3, each of the plurality of piezoelectric bodies is sandwiched between electrodes, and each of first vibrator 2 and second vibrator 3 has a sandwich structure of a piezoelectric body and electrodes. The number of piezoelectric bodies included in first vibrator 2 and second vibrator 3 is, for example, an even number such as two, four, and six. The electrode is, for example, a thin metal plate made of copper, phosphor bronze, or the like.

First vibrator 2 and second vibrator 3 are directly attached to squeegee 1, for example. First vibrator 2 and second vibrator 3 are disposed at a distance equal to or larger than the width of powder layer 8 to be formed.

Examples of the piezoelectric body include piezoelectric ceramics such as lead zirconate titanate-based ceramic (PbTiO₃—PbZrO₃-based ceramics, commonly known as PZT) and barium titanate (BaTiO₃), and piezoelectric single crystals such as quartz and LiNbO₃.

When the piezoelectric body is a piezoelectric ceramic such as PZT, the thickness per sheet is, for example, more than or equal to 2 mm and less than or equal to 5 mm.

Each of first vibrator 2 and second vibrator 3 has a sandwich structure in which a piezoelectric body is sandwiched between a metal front plate and a backing plate, and may be a Langevin type vibrator in which the entire length is a half wavelength length. In this case, the Langevin type vibrator is coupled to squeegee 1. Specifically, the Langevin type vibrator has a structure in which a front plate and a backing plate disposed on both sides of a piezoelectric body such as PZT are tightened with bolts. The front plate and the backing plate are each, for example, made of duralumin. The bolt is made of steel or titanium alloy, for example. A screw hole for connecting to squeegee 1 is provided at the center of the front plate, and squeegee 1 is inserted and tightened into the screw hole, and thus first vibrator 2 and second vibrator 3 are firmly attached and connected to squeegee 1. This can transmit the vibration generated by first vibrator 2 to squeegee 1. Conversely, the vibration of squeegee 1 can be transmitted to and absorbed by second vibrator 3.

First vibrator 2 is a vibrator that excites a wave, and positive charges and negative charges are applied to metal plates provided on both end surfaces of the piezoelectric body. This converts electrical energy into mechanical energy. Specifically, an electric signal is converted into mechanical vibration, and first vibrator 2 vibrates at a high frequency. This vibration propagates to squeegee 1, and a traveling wave propagates to squeegee 1.

On the other hand, second vibrator 3 is a vibrator that absorbs a wave, the piezoelectric body receives the vibration of the traveling wave transmitted to squeegee 1, and the piezoelectric body vibrates. At this time, positive charges and negative charges are generated in the metal plates provided on the end surfaces on both sides of the piezoelectric body. That is, vibration is absorbed by converting mechanical energy into electric energy. Specifically, the mechanical vibration is converted into an electric signal and absorbed as an electric signal, whereby second vibrator 3 absorbs the high-frequency vibration transmitted through squeegee 1. For example, as a method of absorbing an electric signal, there is a method of absorbing an electric signal as a resistance component.

By providing first vibrator 2 that excites a wave at the first end of squeegee 1 and providing second vibrator 3 that absorbs a wave at the second end of squeegee 1 like this, a traveling wave is transmitted to squeegee 1. This is because the wave excited by first vibrator 2 is absorbed by second vibrator 3, and thus the wave formed by first vibrator 2 is reflected on the second end side of squeegee 1, and a phenomenon in which a sinusoidal standing wave is generated due to resonance between the wave before reflection and the reflected wave does not occur.

Squeegee 1 vibrates, for example, at a frequency of more than or equal to 2 kHz and less than or equal to 300 kHz. That is, squeegee 1 vibrates at a high frequency in the vicinity of the ultrasonic band. Specifically, when powder 4 supplied onto sheet 5 passes through the gap between squeegee 1 and sheet 5, high-frequency vibration of squeegee 1 is transmitted to powder 4 to increase the flowability of powder 4. Thus, powder clogging when powder 4 passes through the gap between squeegee 1 and sheet 5 is suppressed. This is because, when squeegee 1 vibrates at a high frequency, powder 4 in contact with squeegee 1 is less likely to be subjected to frictional resistance due to the powder pressure and increases its flowability, and as a result, stagnation and aggregation of powder 4 are suppressed.

Aggregation of powder 4 positioned in the vicinity of squeegee 1 is also suppressed because frictional force between the powder particles is reduced by the vibration of squeegee 1 and the flowability of the powder is increased.

The flowability of powder 4 tends to increase as the frequency of vibration of squeegee 1 increases. Thus, the flowability of powder 4 can be sufficiently enhanced by vibrating squeegee 1 at a frequency of more than or equal to 2 kHz in the high frequency region in the vicinity of the ultrasonic band. However, when the frequency is too high, the vibration is easily attenuated, and thus the vibration of squeegee 1 is less likely to be transmitted through powder 4. When the frequency is less than or equal to 300 kHz, the flowability of powder 4 can be sufficiently enhanced.

Thus, even when powder 4 having a particle size of less than or equal to 30 μm and low flowability is used, squeegee 1 that is vibrating prevents powder 4 from stagnating or aggregating and allows powder 4 to pass through the gap between squeegee 1 and sheet 5, and thus, the film thickness and the filling rate of powder 4 are adjusted. Therefore, powder layer 8 having little variation in basis weight can be formed.

The direction of the high-frequency vibration of squeegee 1 includes at least either a component in a vertical direction or a component in a horizontal direction. That is, squeegee 1 vibrates in at least either the vertical direction or the horizontal direction.

The vertical direction is a direction vertical to a main surface of squeegee 1. The main surface of squeegee 1 is a surface in contact with powder 4 in squeegee 1. The main surface of squeegee 1 is, for example, a surface parallel to the longitudinal direction of squeegee 1 and disposed on sheet 5 side in squeegee 1. In the vibration in the vertical direction, a longitudinal wave (wave in a vibration direction in which squeegee 1 approaches and separates from powder 4) is easily transmitted to powder 4.

The component in the vertical direction of the high-frequency vibration of squeegee 1 has a large effect on reduction in frictional resistance between powders 4. This is because the vibration in the vertical direction is a vibration direction that squeegee 1 approaches to and separates from powder 4, thus, the collision between the particles of powders 4 is repeated, and the vibration is easily transmitted to powder 4. Since high frequency waves are generally less likely to propagate, vibrations between powders 4 may be less likely to be transmitted. However, vibrations in the vertical direction are particularly likely to be transmitted to powders 4.

The horizontal direction is a direction parallel to the main surface of squeegee 1 and parallel to an axis of squeegee 1. In the vibration in the horizontal direction, a lateral wave (a wave in a direction in which squeegee 1 rubs against powder 4 and vibrates) is easily transmitted to powder 4. Here, the axis of squeegee 1 means an axis in a direction parallel to the width direction of sheet 5. The axis of squeegee 1 may be parallel to the longitudinal direction of squeegee 1.

The horizontal component of the high-frequency vibration of squeegee 1 greatly contributes to a decrease in frictional force between squeegee 1 and powder 4 in addition to a decrease in frictional resistance between powders 4. When the vibration component in the vertical direction is too large, the vibration is excessively transmitted to powder 4, and powder 4 greatly vibrates to possibly cause the film thickness variation to increase. However, because the vibration component in the horizontal direction can also cause the frictional force between squeegee 1 and powder 4 to decrease, the flowability of powder 4 can be particularly enhanced.

The direction of the high-frequency vibration of squeegee 1 may be only the vertical direction or only the horizontal direction. However, by using the high-frequency vibration in the vicinity of the ultrasonic band in both the vertical direction and the horizontal direction in combination, the flowability of powder 4 can be further enhanced. For example, this is because, when one particle of powder 4 is focused, the vibration direction of powder 4 becomes random and vibration is applied to the entire surface of powder 4, there is no surface where the vibration is not transmitted to cause the frictional resistance to increase, and thus, the flowability of powder 4 improves.

When squeegee 1 vibrates at a high frequency in the vicinity of the ultrasonic band in the vertical direction and the horizontal direction, the magnitude of vibration of squeegee 1 in the horizontal direction is larger than, for example, the magnitude of vibration of squeegee 1 in the vertical direction. That is, in squeegee 1, for example, the magnitude of vibration of the lateral wave component of powder 4 (the direction in which squeegee 1 rubs against powder 4 and vibrates) is larger than the magnitude of vibration of the longitudinal wave component of powder 4 (the vibration direction in which squeegee 1 approaches and separates from powder 4). In this case, the frictional resistance at the interface between squeegee 1 and powder 4 where the frictional resistance tends to be particularly high can be reduced by the vibration of squeegee 1 in the horizontal direction, and the frictional resistance between powders 4 can also be reduced. Thus, the flowability of powder 4 can be further enhanced.

The magnitude of vibration of squeegee 1 in the vertical direction is, for example, more than or equal to 10 nm. That is, the amplitude of squeegee 1 in the vertical direction is, for example, more than or equal to 10 nm. In this case, the frictional resistance between the particles of powder 4 can be sufficiently reduced, and the flowability of powder 4 can be further enhanced. The amplitude of squeegee 1 in the vertical direction is, for example, less than or equal to 10 μm. With this configuration, powder 4 can be suppressed from being scattered as dust and contaminating the surroundings due to excessive vibration of powder 4.

The magnitude of vibration of squeegee 1 in the horizontal direction is, for example, more than or equal to 20 nm. That is, the amplitude of squeegee 1 in the horizontal direction is, for example, more than or equal to 20 nm. In this case, the frictional resistance at the interface between squeegee 1 and powder 4 can be sufficiently reduced, and the flowability of powder 4 can be further enhanced. The amplitude of squeegee 1 in the horizontal direction is, for example, less than or equal to 20 μm. With this configuration, powder 4 can be suppressed from being scattered as dust and contaminating the surroundings due to excessive vibration of powder 4.

Squeegee 1 has, for example, a cylindrical shape whose axial direction is long, and is disposed, for example, such that the axial direction of the cylinder (height direction of the cylinder) is parallel to the upper surface of sheet 5 and intersects (for example, orthogonal to) with the relative movement direction of sheet 5 with respect to squeegee 1. The longitudinal direction of squeegee 1 is the axial direction of the cylinder. In squeegee 1, the traveling wave travels in the axial direction. The shape of squeegee 1 is not particularly limited, and it may be, for example, a polygonal column having a polygonal section. The area of the section of squeegee 1 does not have to be constant, and the thickness of squeegee 1 may change along the longitudinal direction.

To increase the amplitude of squeegee 1 in the horizontal direction, the polarization direction of the piezoelectric body of each of first vibrator 2 and second vibrator 3 is made to coincide with the thickness direction of the vibrator. That is, first vibrator 2 vibrates so as to expand and contract in the thickness direction, and second vibrator 3 absorbs the vibration by expanding and contracting in the thickness direction.

### [Powder Coating Device]

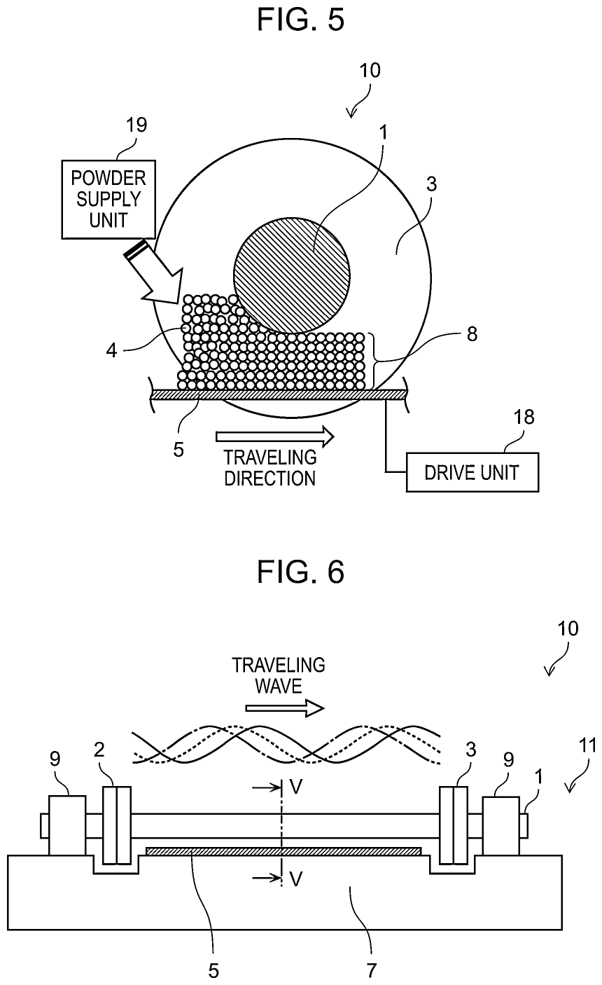

Next, a powder coating device according to the present exemplary embodiment will be described with reference to FIGS. 5 and 6. FIG. 5 is a diagram illustrating the vicinity of powder amount adjustment unit 11 of powder coating device 10 according to the present exemplary embodiment. FIG. 6 is a diagram illustrating powder coating device 10 according to the present exemplary embodiment as viewed from the front. FIG. 5 illustrates a section taken along line V-V in FIG. 6. Stage 7 is not illustrated in FIG. 5. FIG. 6 schematically illustrates a vibration waveform when squeegee 1 vibrates with a traveling wave when squeegee 1 is viewed from the front. In FIG. 6, the time change of the vibration waveform is illustrated by waveforms indicated by different line types. In FIG. 6, “as viewed from the front” is a case of being viewed from the front in a relative movement direction of powder 4 with respect to squeegee 1.

As illustrated in FIGS. 5 and 6, powder coating device 10 includes powder amount adjustment unit 11, a pair of support columns 9 supporting squeegee 1 of powder amount adjustment unit 11, drive unit 18 that moves sheet 5, and powder supply unit 19. Powder amount adjustment unit 11 is disposed such that a gap is formed between squeegee 1 and sheet 5. With this configuration, squeegee 1 adjusts the thickness of powder 4 supplied onto sheet 5 by powder supply unit 19. Sheet 5 is supported by, for example, stage 7. Sheet 5 may be supported by a conveyance roll or the like.

In powder coating device 10, drive unit 18 conveys sheet 5 along the traveling direction. Powder coating device 10 continuously supplies powder 4 to the surface of conveyed sheet 5 by using powder supply unit 19. Powder coating device 10 adjusts the film thickness and the filling rate of powder 4 supplied to the surface of sheet 5 using squeegee 1, and reduces variation in the basis weight while setting the basis weight of powder layer 8 to a desired basis weight.

As described above, the traveling wave is propagated to squeegee 1 in powder amount adjustment unit 11. Since powder 4 is leveled using the vibration of the traveling wave in powder coating device 10, it is possible to suppress variation in powder basis weight in the width direction caused by the antinode and node portions of the stationary wave. That is, powder layer 8 having little variation in basis weight in the width direction can be formed.

Drive unit 18 is, for example, a conveyance device that moves sheet 5 in a predetermined direction. The conveyance device is not particularly limited as long as sheet 5 can be conveyed, and any device may be used. The conveyance device may be, for example, a conveyance device that can continuously feed out sheet 5 wound in a roll, or a conveyance device that can intermittently feed out sheet 5.

A guide roller that rotates with the movement of sheet 5, a control device that corrects the meandering of sheet 5, and the like may be provided on a conveyance path of sheet 5. Drive unit 18 may be a device that moves squeegee 1 and powder supply unit 19. That is, drive unit 18 relatively moves sheet 5 in a predetermined direction with respect to squeegee 1 and powder supply unit 19.

In the present exemplary embodiment, sheet 5 is, for example, a long belt-shaped thin plate and is wound. Sheet 5 is not limited to the long belt-shaped thin plate. For example, sheet 5 having a desired shape may be fed out from the conveyance device, and new sheet 5 may be fed out from the conveyance device after the coating of powder 4 to sheet 5 is completed. Sheet 5 does not have to be wound in a roll shape. That is, sheet 5 only needs to have a shape that allows powder 4 to be applied thereto by using powder coating device 10. Thus, the shape of sheet 5 is not particularly limited.

Powder supply unit 19 supplies powder 4 onto a surface of sheet 5. In the present exemplary embodiment, powder supply unit 19 is, for example, a hopper. The hopper stores powder 4 therein and supplies powder 4 to a surface of sheet 5.

Powder supply unit 19 is disposed upstream of squeegee 1 in the traveling direction of sheet 5. Powder 4 supplied to a surface of sheet 5 by powder supply unit 19 reaches squeegee 1 as sheet 5 moves. In the present exemplary embodiment, a hopper is used as powder supply unit 19, but the power supply unit is not limited to this, and powder supply unit 19 may be any device that can supply powder 4 to a surface of sheet 5. Powder supply unit 19 may be, for example, a feeder such as a screw feeder.

The pair of support columns 9 supporting squeegee 1 is disposed on the outer side with respect to first vibrator 2 and second vibrator 3 in such a manner as to sandwich first vibrator 2 and second vibrator 3. That is, the pair of support columns 9 is installed outside the region where the traveling wave propagates in squeegee 1. The pair of support columns 9 supports squeegee 1 at both ends of squeegee 1. When support column 9 is disposed on the inner side of first vibrator 2 and second vibrator 3 (that is, between first vibrator 2 and second vibrator 3), a traveling wave propagating on squeegee 1 attenuates when passing through support column 9. This attenuation can be suppressed by installing support column 9 on the outer side with respect to first vibrator 2 and second vibrator 3. Since the traveling wave has a smaller amplitude than the sinusoidal standing wave, it is important to have a device configuration that suppresses attenuation of the wave in this manner. This is because the amplitude of the sinusoidal standing wave is amplified by resonance, whereas the amplitude of the traveling wave is not amplified. The pair of support columns 9 is standing from stage 7 in such a manner as to sandwich a region where sheet 5 moves, for example.

In the present exemplary embodiment, squeegee 1 has a cylindrical shape, and both ends in the axial direction of the cylinder of squeegee 1 are fixed and disposed by the support column 9 with a bearing (not illustrated) such that squeegee 1 slides in the horizontal direction. The sliding amount in the horizontal direction can be adjusted by attaching a stopper or the like to squeegee 1. Both axial ends of the cylinder of squeegee 1 are formed in a shape to be inserted into the bore of a circular bearing, and the difference between the diameter of squeegee 1 and the bearing diameter is adjusted, whereby the amount of vibration in the vertical direction can be adjusted. The relationship between the amplitude in the horizontal direction and the amplitude in the vertical direction can be adjusted in this manner to create a relationship in which the amplitude in the horizontal direction is larger than the amplitude in the vertical direction.

Powder coating device 10 does not have to include support column 9 as long as squeegee 1 is disposed in such a manner as to form a gap with sheet 5. For example, when powder amount adjustment unit 11 is driven by drive unit 18, squeegee 1 may be attached to drive unit 18.

### [Method for Producing Powder Layer]

Hereinafter, a method for producing powder layer 8 will be described. Powder layer 8 can be produced by using powder coating device 10.

The method for producing powder layer 8 includes supplying powder 4 to a surface of sheet 5 such as a current collector while moving sheet 5 in a predetermined direction (powder supply step), and adjusting the thickness and the basis weight of powder 4 supplied to the surface of sheet 5 using squeegee 1 (powder alignment step).

First, powder 4 is prepared. The raw material of powder 4 is not particularly limited, but for example, a group of particles containing at least either an active material or a solid electrolyte may be used. In the case of using a particle group containing an active material, a mixture obtained by adding an appropriate additive (for example, a binder, a conductive material, a solid electrolyte, and the like) to the active material is mixed to prepare powder 4. Examples of the mixing method include a method of mixing with a mortar, a ball mill, a mixer, or the like. In particular, a method of mixing powder 4 without using a solvent or the like is preferable because the method does not cause material deterioration.

In the powder supply step, powder 4 is supplied to a surface of sheet 5 by using powder supply unit 19 such as a hopper while sheet 5 is moved in a predetermined direction. The base material to which powder 4 is supplied may have a shape other than a sheet shape, for example, a plate shape or a block shape. In this case, the movement of the base material in the powder supply step may be a form in which the plate or the block intermittently flows.

The powder alignment step is a step of aligning powder 4 on the surface of sheet 5 using squeegee 1 of powder coating device 10. That is, in the powder alignment step, the thickness and the basis weight of powder 4 supplied to the surface of sheet 5 are adjusted using squeegee 1. Powder layer 8 is thus formed. At this time, squeegee 1 vibrates, for example, at a frequency of more than or equal to 2 kHz and less than or equal to 300 kHz. In squeegee 1, a traveling wave propagates from first vibrator 2 toward second vibrator 3.

The method for producing powder layer 8 may further include a powder sheet formation step. The powder sheet formation step is, for example, a step of compressing powder layer 8 formed of powder 4 aligned on sheet 5 using a pressing machine such as a roll press. This configuration forms a compressed powder layer obtained by compressing powder layer 8 on the surface of sheet 5.

In this manner, in the method for producing powder layer 8, the powder supply step and the powder alignment step are performed in this order, whereby powder layer 8 formed of powder 4 is formed on the surface of sheet 5. Such a stack of sheet 5 and powder layer 8 can be used for an energy device. For example, when a current collector is used as sheet 5 and a group of particles containing an active material is used as powder 4, an electrode for an energy device can be produced.

The energy device produced using powder coating device 10 can have powder layer 8 directly coated with powder 4 by imparting flowability to powder 4 and having little variation in basis weight. Thus, according to the method for producing powder layer 8, the step of directly applying powder 4 is used without using the step of dispersing powder 4 in a solvent or the like, applying powder 4, and then drying the solvent. Thus, it is possible to prevent deterioration of the material due to the solvent, leading to an increase in capacity of the energy device. In addition, it is possible to suppress an increase in cost due to using and drying a solvent. Further, a large amount of energy consumption in the drying step can be suppressed, and the production method is environmentally friendly. On the other hand, since the uniformity of the basis weight of powder layer 8 is high, the quality as an electrode in the energy device can be improved, and a high-capacity energy device having good quality can be produced at low cost.

### [Powder Layer]

Next, powder layer 8 formed using powder coating device 10 will be described.

Powder layer 8 according to the present exemplary embodiment is used, for example, in an energy device. The film thickness of powder layer 8 is, for example, more than or equal to 30 μm. Powder layer 8 contains a powder including at least one type of particle material. The concentration of the solvent contained in powder layer 8 is less than or equal to 50 ppm. The variation in basis weight of powder layer 8 is small.

With this configuration, powder layer 8 in which the variation in the coating weight is reduced and deterioration due to the solvent is suppressed is realized. In addition, because there is no need to dry the solvent, the energy consumption for drying the solvent can be reduced, and thus, the environmental load can be suppressed and the increase in production cost can be suppressed. Thus, using powder layer 8 as an energy device makes it possible to increase the capacity and quality of the energy device, reduce the environmental load, and reduce the cost.

Powder layer 8 may be a compressed powder layer obtained by pressing powder layer 8 formed by powder coating device 10.

Powder layer 8 of the present exemplary embodiment can be used for, for example, an all-solid-state battery.

Hereinafter, details of a case where powder layer 8 is used for an all-solid-state battery will be described.

Powder layer 8 is formed on sheet 5 as a current collector, for example, and is used for an electrode (that is, a positive electrode or a negative electrode) of an all-solid-state battery. The electrode includes a current collector and powder layer 8.

The electrode may further include another layer located between the current collector and powder layer 8. The another layer is, for example, a connection layer including a conductive carbon material or the like.

The film thickness of powder layer 8 is more than or equal to 30 μm. The upper limit value of the film thickness of powder layer 8 is not particularly limited, but the film thickness of powder layer 8 is, for example, less than or equal to 2000 μm.

Powder layer 8 contains powder 4 formed of at least one type of particle material.

The concentration of the solvent contained in powder layer 8 is less than or equal to 50 ppm. That is, powder layer 8 does not substantially contain a solvent. Here, substantially does not contain means not containing at all or inevitably containing less than or equal to 50 ppm as impurities or the like. The concentration of the solvent is a concentration on a weight basis.

The size of powder layer 8 in plan view is, for example, more than or equal to 30 mm×30 mm. The upper limit of the size of powder layer 8 in plan view is not particularly limited, but the size of powder layer 8 in plan view is, for example, less than or equal to 300 mm×600 mm.

In any region of 30 mm×30 mm on the surface of powder layer 8, the variation in the basis weight of powder layer 8 is, for example, less than or equal to 8%.

The basis weight is measured by, for example, the following method. First, powder layer 8 and the current collector are pressed from above and below to be compacted, then, powder layer 8 and the current collector are punched into a circle having a diameter more than or equal to 5 mm and less than or equal to 9 mm, and the total weight of punched powder layer 8 and the current collector is measured. Then, the weight of the current collector of the same lot punched out with a diameter of more than or equal to 5 mm and less than or equal to 9 mm measured in advance is subtracted from the total weight to determine the weight of powder layer 8. The basis weight can be obtained by dividing the weight by the area of a punched circle having a diameter of more than or equal to 5 mm and less than or equal to 9 mm.

The variation in the basis weight is measured by, for example, the following method. First, any region of 30 mm×30 mm on the surface of powder layer 8 in plan view is selected. This region may be a central region of the surface of powder layer 8 or a region including an end of powder layer 8. Then, within the range of this region, for example, five or more circles each having a diameter of more than or equal to 5 mm and less than or equal to 9 mm are punched out, and the basis weight is measured using the above-described method. From the viewpoint of improving the measurement accuracy of the variation, nine or more places may be punched. The variation in the basis weight is calculated by dividing the difference (specifically, an absolute value of the difference) between an average of the basis weight of all the punched places and the basis weight of a place having the largest difference from the average among the basis weights of the punched places by the average. That is, the variation in the basis weight being less than or equal to 8% means that the difference of the basis weight from the average is less than or equal to 8% of the average at any punched place.

As described above, powder layer 8 is formed by aligning powder 4 in powder layer 8 while imparting flowability to powder 4 by applying high-frequency vibration to powder 4 supplied to surface of sheet 5. Since squeegee 1 vibrates with the traveling wave, the variation in the basis weight of powder layer 8 is small also in the width direction, and thus powder layer 8 having a size of more than or equal to 30 mm×30 mm and a thickness of more than or equal to 30 μm can be produced with high quality. Thus, powder layer 8 can be used for a large and high-capacity energy device.

Powder layer 8 is produced through, for example, a coating step substantially free of a solvent. Thus, powder layer 8 substantially free of a solvent can be formed. For this reason, powder layer 8 is not damaged by a solvent. Thus, deterioration of powder layer 8 is suppressed, the variation in the basis weight of powder 4 in powder layer 8 is small, and thus powder layer 8 of a large and high-capacity energy device having a high capacity and excellent quality can be formed.

Powder layer 8 can be used for, for example, a positive electrode, a negative electrode, or a solid electrolyte layer of an energy device such as an all-solid-state battery.

When powder layer 8 is used for a positive electrode, for example, sheet 5 is a positive electrode current collector, and powder layer 8 containing powder 4 is a positive electrode mixture layer. That is, the positive electrode mixture layer is formed on the positive electrode current collector. Powder 4 in the positive electrode mixture layer contains, for example, a positive electrode active material and a solid electrolyte having ion conductivity.

When powder layer 8 is used for a negative electrode, for example, sheet 5 is a negative electrode current collector, and powder layer 8 containing powder 4 is a negative electrode mixture layer. That is, the negative electrode mixture layer is formed on the negative electrode current collector. Powder 4 in the negative electrode mixture layer contains, for example, a negative electrode active material and a solid electrolyte having ion conductivity.

When powder layer 8 is used as a solid electrolyte layer, for example, powder layer 8 containing powder 4 is a solid electrolyte layer. The solid electrolyte layer is formed on a surface of the positive electrode mixture layer formed on the positive electrode current collector or a surface of the negative electrode mixture layer formed on the negative electrode current collector. That is, sheet 5 is, for example, a positive electrode mixture layer formed on a positive electrode current collector or a negative electrode mixture layer formed on a negative electrode current collector. Powder 4 in the solid electrolyte layer includes, for example, a solid electrolyte having ion conductivity.

The concentration of the solvent contained in the positive electrode mixture layer, the negative electrode mixture layer, and the solid electrolyte layer is less than or equal to 50 ppm. That is, the positive electrode mixture layer, the negative electrode mixture layer, and the solid electrolyte layer are substantially free of a solvent. Here, substantially free of a solvent means a case where these layers do not contain a solvent at all or a case where these layers inevitably contains less than or equal to 50 ppm of a solvent as impurities or the like.

The solvent is, for example, an organic solvent. The method of measuring the solvent is not particularly limited, and the solvent can be measured by using, for example, gas chromatography, a mass change method, or the like. Examples of the organic solvent include nonpolar organic solvents such as heptane, xylene, and toluene, polar organic solvents such as tertiary amine-based solvents, ether-based solvents, thiol-based solvents, and ester-based solvents, and combinations thereof. Examples of the tertiary amine-based solvent include triethylamine, tributylamine, and triamylamine. Examples of the ether-based solvent include tetrahydrofuran and cyclopentyl methyl ether. Examples of the thiol-based solvent include ethane mercaptan. Examples of the ester-based solvent include butyl butyrate, ethyl acetate, and butyl acetate.

Next, the materials used for the positive electrode mixture layer, the negative electrode mixture layer, and the solid electrolyte layer will be described in detail.

The positive electrode active material is a material in which metal ions such as lithium (Li) are inserted into or removed from a crystal structure at a higher potential than the negative electrode, and oxidation or reduction is performed in association with insertion or removal of the metal ions such as lithium. The type of the positive electrode active material is appropriately selected according to the type of the all-solid-state battery, and examples thereof include an oxide active material and a sulfide active material.

As the positive electrode active material according to the present exemplary embodiment, for example, an oxide active material (lithium-containing transition metal oxide) is used. Examples of the oxide active material include LiCoO₂, LiNiO₂, LiMn₂O₄, LiCoPO₄, LiNiPO₄, LiFePO₄, LiMnPO₄, compounds obtained by substituting transition metal of these compounds with one or two different elements. Known materials such as LiNi_{1/3}Co_{1/3}Mn_{1/3}O₂, LiNi_{0.8}Co_{0.15}Al_{0.05}O₂, and LiNi_{0.5}Mn_{1.5}O₂ are used as the compounds obtained by substituting the transition metal of the above compounds with one or two different elements. One type or a combination of two or more types may be used as the material of the positive electrode active material.

Examples of the shape of the positive electrode active material include a particle shape. In a case where the positive electrode active material has a particle shape, the particle size of the positive electrode active material is, for example, in a range from 50 nm to 30 μm inclusive, and may be in a range from 1 μm to 15 μm inclusive. When the particle size of the positive electrode active material is set to more than or equal to 50 nm, handling properties tend to improve. On the other hand, when the particle size is set to less than or equal to 30 μm, the surface area is increased by using an active material having a small particle size, and a positive electrode having a high capacity tends to be obtained. The particle size of the material contained in the positive electrode mixture layer or the negative electrode mixture layer in the present description is, for example, D50 described above.

The surface of the positive electrode active material may be coated with a coating layer. This is because the reaction between the positive electrode active material (for example, oxide active material) and the solid electrolyte (for example, sulfide-based solid electrolyte) can be suppressed. Examples of the material of the coating layer include Li-ion conductive oxides such as LiNbO₃, Li₃PO₄, and LiPON. The average thickness of the coating layer is, for example, in a range from 1 nm to 20 nm inclusive, and may be in a range from 1 nm to 10 nm inclusive.

As the proportion of the positive electrode active material and the solid electrolyte contained in the positive electrode mixture layer, the weight ratio may be in a range from 1 to 99 inclusive or in a range from 2.3 to 19 inclusive when positive electrode active material/solid electrolyte=weight ratio holds in terms of weight. By setting the weight ratio within this range, both a lithium ion conduction path and an electron conduction path in the positive electrode mixture layer are likely to be secured.

The negative electrode active material is a material in which metal ions such as lithium are inserted into or removed from a crystal structure at a lower potential than the positive electrode, and oxidation or reduction is performed in association with insertion or removal of the metal ions such as lithium.

As the negative electrode active material in the present exemplary embodiment, for example, known materials such as lithium, metal easily alloyed with lithium such as indium, tin, or silicon, a carbon material such as hard carbon or graphite, and an oxide active material such as Li₄Ti₅O₁₂ or SiOₓ are used. In addition, as the negative electrode active material, a composite or the like obtained by appropriately mixing the above-described negative electrode active materials may also be used.

The particle size of the negative electrode active material is, for example, less than or equal to 30 μm. By using an active material having a small particle size, the surface area is increased, and a high capacity can be achieved.

As the proportion of the negative electrode active material and the solid electrolyte contained in the negative electrode mixture layer, the weight ratio may be in a range from 0.6 to 19 inclusive or in a range from 1 to 9 inclusive when negative electrode active material/solid electrolyte=weight ratio holds in terms of weight. By setting the weight ratio within this range, both a lithium ion conduction path and an electron conduction path in the negative electrode mixture layer are likely to be secured.

The solid electrolyte may be appropriately selected according to the conductive ion species (for example, lithium ions). Examples of the solid electrolyte include a sulfide-based solid electrolyte, an oxide-based solid electrolyte, and a halide-based solid electrolyte.

The type of the sulfide-based solid electrolyte in the present exemplary embodiment is not particularly limited, and examples of the sulfide-based solid electrolyte include Li₂S—SiS₂, LiI—Li₂S—SiS₂, LiI—Li₂S—P₂S₅, LiI—Li₂S—P₂O₅, LiI—Li₃PO₄—P₂S₅, and Li₂S—P₂S₅. In particular, from the viewpoint of excellent lithium ion conductivity, the sulfide-based solid electrolyte may contain Li, P, and S. One type or a combination of two or more types may be used as the sulfide-based solid electrolyte. In addition, the sulfide-based solid electrolyte may be crystalline, amorphous, or glass ceramics. The above description of “Li₂S—P₂S₅” means a sulfide-based solid electrolyte obtained by using a raw material composition containing Li₂S and P₂S₅, and the same applies to other descriptions.

In the present exemplary embodiment, the sulfide-based solid electrolyte is, for example, a sulfide-based glass ceramic containing Li₂S and P₂S₅, and the proportion of Li₂S and P₂S₅ may be in a range from 2.3 to 4 inclusive or in a range from 3 to 4 inclusive when Li₂S/P₂S₅=molar ratio holds in terms of mole. By setting the molar ratio within this range, a crystal structure having high ion conductivity can be obtained while a lithium concentration that influences battery characteristics is maintained.

Examples of the shape of the sulfide-based solid electrolyte according to the present exemplary embodiment include a particle shape such as a perfect spherical shape or an elliptical spherical shape. When the sulfide-based solid electrolyte material has a particle shape, the particle size of the sulfide-based solid electrolyte is not particularly limited, but may be less than or equal to 30 μm, less than or equal to 20 μm, or less than or equal to 10 μm because the filling rate in the positive electrode or the negative electrode tends to improve. Meanwhile, the particle size of the sulfide-based solid electrolyte may be more than or equal to 0.001 μm or more than or equal to 0.01 μm.

Next, the oxide-based solid electrolyte according to the present exemplary embodiment will be described. The type of the oxide-based solid electrolyte is not particularly limited, and examples thereof include LiPON, Li₃PO₄, Li₂SiO₂, Li₂SiO₄, Li_{0.5}La_{0.5}TiO₃, Li_{1.3}Al_{0.3}Ti_{0.7}(PO₄)₃, La_{0.51}Li_{0.34}TiO_{0.74}, and Li_{1.5}Al_{0.5}Ge_{1.5}(PO₄)₃. One type or a combination of two or more types may be used as the material of the oxide-based solid electrolyte.

Next, details of the positive electrode current collector and the negative electrode current collector will be described.

The positive electrode according to the present exemplary embodiment includes, for example, a positive electrode current collector made of a metal foil or the like. As the positive electrode current collector, for example, a foil-like body, a plate-like body, a mesh-like body, or the like made of aluminum, gold, platinum, zinc, copper, stainless steel (SUS), nickel, tin, titanium, or an alloy of two or more types thereof is used.

The thickness, shape, and the like of the positive electrode current collector may be appropriately selected according to the application of the positive electrode.

The negative electrode according to the present exemplary embodiment includes, for example, a negative electrode current collector made of a metal foil or the like. As the negative electrode current collector, for example, a foil-like body, a plate-like body, a mesh-like body, or the like made of SUS, gold, platinum, zinc, copper, nickel, titanium, tin, or an alloy of two or more types thereof is used.

The thickness, shape, and the like of the negative electrode current collector may be appropriately selected according to the application of the negative electrode.

### Other Exemplary Embodiments

Although the powder amount adjustment unit and the powder coating device according to the present disclosure have been described above based on the exemplary embodiments, the present disclosure is not limited to these exemplary embodiments. Embodiments that are various modifications of the exemplary embodiments conceivable by those skilled in the art, and other embodiments constructed by combining some components of the exemplary embodiments are also included in the scope of the present disclosure without departing from the gist of the present disclosure.

For example, in the above exemplary embodiment, squeegee 1 vibrates at a high frequency in the vicinity of the ultrasonic band, but the squeegee is not limited to this. The frequency of vibration of squeegee 1 may be set according to the characteristics of powder 4, and it may be, for example, less than or equal to 2 KHz.

### INDUSTRIAL APPLICABILITY

The powder amount adjustment unit and the powder coating device according to the present disclosure can form a uniform powder layer with reduced variation in film thickness without using a solvent, and thus can be used for forming various powder layers such as a mixture layer of a high-quality all-solid-state battery.

### REFERENCE MARKS IN THE DRAWINGS

1, 21 squeegee
2 first vibrator
3 second vibrator
4, 24 powder
5, 25 sheet
6 mask
7 stage
8, 28 powder layer
9 support column
10, 30 powder coating device
11 powder amount adjustment unit
18 drive unit
19 powder supply unit

1. A powder amount adjustment unit that adjusts an amount of powder by leveling the powder supplied onto a base material,
the powder amount adjustment unit comprising:
a squeegee including a first end and a second end;
a first vibrator that is disposed at the first end of the squeegee and excites a wave at the first end; and
a second vibrator that is disposed at the second end of the squeegee and absorbs the wave at the second end,
wherein the squeegee vibrates with a traveling wave from the first end toward the second end.

2. The powder amount adjustment unit according to claim 1, wherein the squeegee contains a metal material.

3. The powder amount adjustment unit according to claim 2, wherein the squeegee vibrates at a frequency of more than or equal to 2 kHz and less than or equal to 300 kHz.

4. A powder coating device comprising:
a powder supply unit that supplies powder onto a surface of a base material;
the powder amount adjustment unit according to claim 1 in which the squeegee is disposed with a gap formed between the squeegee and the base material; and
a drive unit that moves the base material with respect to the squeegee in a predetermined direction.

5. The powder coating device according to claim 4,
the powder coating device comprising a pair of support columns supporting the squeegee,
wherein the pair of support columns is disposed on an outer side with respect to the first vibrator and the second vibrator, and the first vibrator and the second vibrator are sandwiched between the pair of support columns.
